(19) United States
(12) Patent Application Publication
(10) Pub. No.: US 2006/0221091 A1
(43) Pub. Date: Oct. 5, 2006

(54) System and method for providing a visual display element for a graphical browser interface

(75) Inventor: Larry B. Pearson, San Antonio, TX (US)

Correspondence Address: HANLEY, FLIGHT & ZIMMERMAN, LLC, 20 N. WACKER DRIVE, SUITE 4220, CHICAGO, IL, 60606, US

(73) Assignee: SBC Knowledge Ventures, L.P., Reno, NV (US)

(21) Appl. No.: 11/093,735

(22) Filed: Mar. 30, 2005

(51) Int. Cl. G06F 9/00

(52) U.S. Cl. 345/589; 715/764; 715/840; 715/836

(57) ABSTRACT

In one embodiment according to the invention, there is disclosed a method for providing a visual display element for a graphical browser interface. The method comprises setting a background color for a region of the graphical browser interface; and providing a visual display element overlaying the background color, wherein the visual display element provides a visual effect of having the same color as the background color, independent of changes to the background color.

### BACKGROUND OF THE INVENTION

Cascading Style Sheets (CSS) are commonly used by web developers to create consistent display characteristics that can be used by all web pages associated with a web application. Cascading Style Sheets are often used to define colors, fonts, and spacing characteristics. The goal of Cascading Style Sheets is to reduce the number of changes to individual web pages when the web developer wishes to make look and feel changes to the web site. Not all look and feel changes to a web site can be made through Cascading Style Sheets, but in many cases making changes to the CSS file can create dramatic changes. Using Cascading Style Sheets, the web developer can make look and feel changes to just the CSS file, and then all of the web pages in the site inherit the changes.

### SUMMARY OF THE INVENTION

In one embodiment according to the invention, there is disclosed a method for providing a visual display element for a graphical browser interface. The method comprises setting a background color for a region of the graphical browser interface; and providing a visual display element overlaying the background color, wherein the visual display element provides a visual effect of having the same color as the background color, independent of changes to the background color.

In further, related embodiments, the visual display element may comprise a button providing a linking functionality via the graphical browser interface; or may comprise a border. The visual display element may comprise a checkerboard pattern of pixel illumination; and the background color may be defined in a cascading style sheet, which may refer to a graphics file defining the visual display element. The visual display element may provide a three dimensional visual effect; and the method may further comprise shading a plurality of edge regions of the button to differing degrees to create the three dimensional visual effect. The differing degrees of shading of the plurality of edge regions may include at least four edge regions comprising at least two different respective color shades lighter than a base color and at least two different respective color shades darker than a base color. Shading the edge regions to differing degrees may comprise creating differing shades of gray shading patterns; or may be created by differing densities of gray shaded pixels.

In another embodiment according to the invention, there is disclosed a system for providing a visual display element for a graphical browser interface. The system comprises means for setting a background color for a region of the graphical browser interface; and means for providing a visual display element overlaying the background color, wherein the visual display element provides a visual effect of having the same color as the background color, independent of changes to the background color.

In a further embodiment according to the invention, there is disclosed a computer-readable medium carrying one or more sequences of instructions for providing a visual display element for a graphical browser interface. Execution of the one or more sequences of instructions by one or more processors causes the one or more processors to perform the steps of setting a background color for a region of the graphical browser interface; and providing a visual display element overlaying the background color, wherein the visual display element provides a visual effect of having the same color as the background color, independent of changes to the background color.

In another embodiment according to the invention, there is disclosed a computer program propagated signal product embodied on a propagated signal on a propagation medium, such propagated signal carrying one or more sequences of instructions for providing a visual display element for a graphical browser interface. Execution of the one or more sequences of instructions by one or more processors causes the one or more processors to perform the steps of setting a background color for a region of the graphical browser interface; and providing a visual display element overlaying the background color, wherein the visual display element provides a visual effect of having the same color as the background color, independent of changes to the background color.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a web page created using prior art techniques, in which a Cascading Style Sheet defines the look and feel of the web page;

FIG. 2 shows a web page illustrating the functionality of buttons created using prior art Cascading Style Sheet techniques;

FIG. 3 shows a graphics file that forms a button on the screen, in accordance with an embodiment of the invention;

FIG. 4 illustrates the interaction between the button of FIG. 3 and a variety of different background colors, in accordance with an embodiment of the invention;

FIG. 5 shows a similar web page to that of FIGS. 1 and 2, modified to use buttons according to an embodiment of the invention;

FIG. 6 shows a web page in which a button according to an embodiment of the invention exhibits the same mouse-over behavior as in the prior art web page of FIGS. 1 and 2;

FIG. 7 shows a visual display element in which the visual effect of a three-dimensional button is accomplished through the use of shading and lines, in accordance with an embodiment of the invention;

FIG. 8 illustrates how the edge regions of the button may be shaded to differing degrees using differing shades of gray shaded pixels, in order to create a three dimensional visual effect in accordance with an embodiment of the invention; and

FIG. 9 illustrates how the edge regions of the button may be shaded to differing degrees using differing densities of gray shaded pixels, in order to create a three dimensional visual effect in accordance with an embodiment of the invention.

### DETAILED DESCRIPTION OF THE INVENTION

Despite the advantages of Cascading Style Sheets (CSS) in allowing style changes to be inherited by all web pages, current practices still require that a web developer redo display elements that are based on pictures, when the color schemes defined by Cascading Style Sheets are changed. For example, graphical display elements used to create borders and buttons are presently implemented as static pictures in JPG, PNG, or GIF formats. When changing the color scheme of a web page that relies in part on borders and buttons created from such graphics files, a web developer is unable to achieve the goal of minimizing the number of individual web page changes needed to create the color scheme changes.

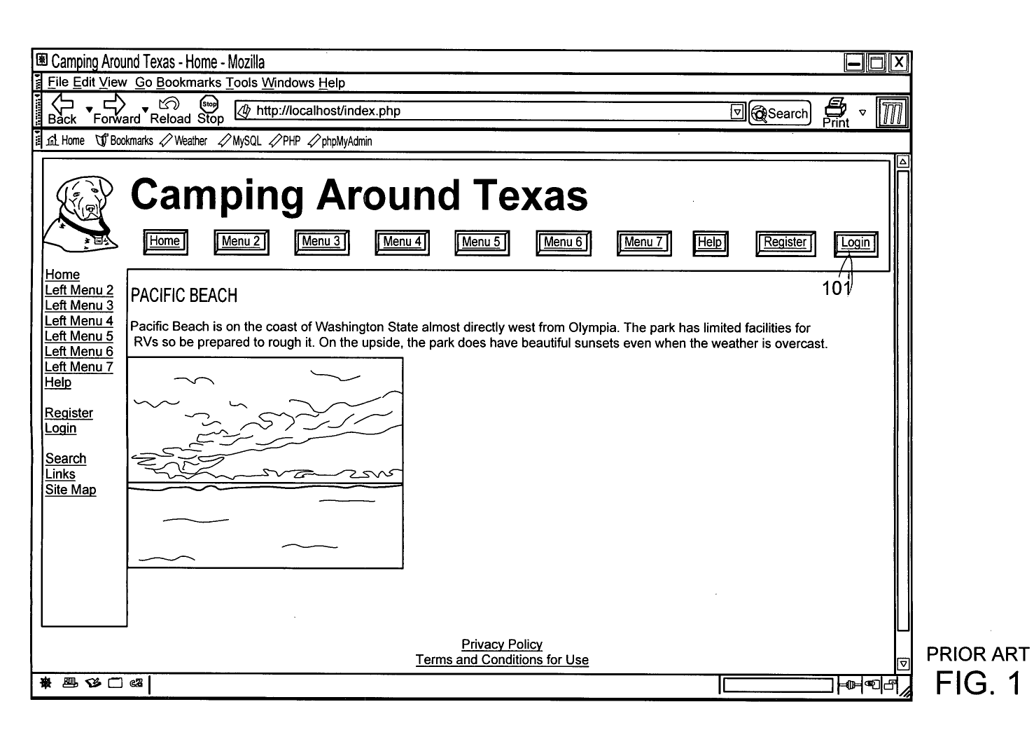

FIG. 1 shows a web page created using prior art techniques, in which a Cascading Style Sheet defines the look and feel of the web page. Buttons such as button 101 along the top row of the page, which are created using CSS directives, are not very attractive and are limited in their flexibility.

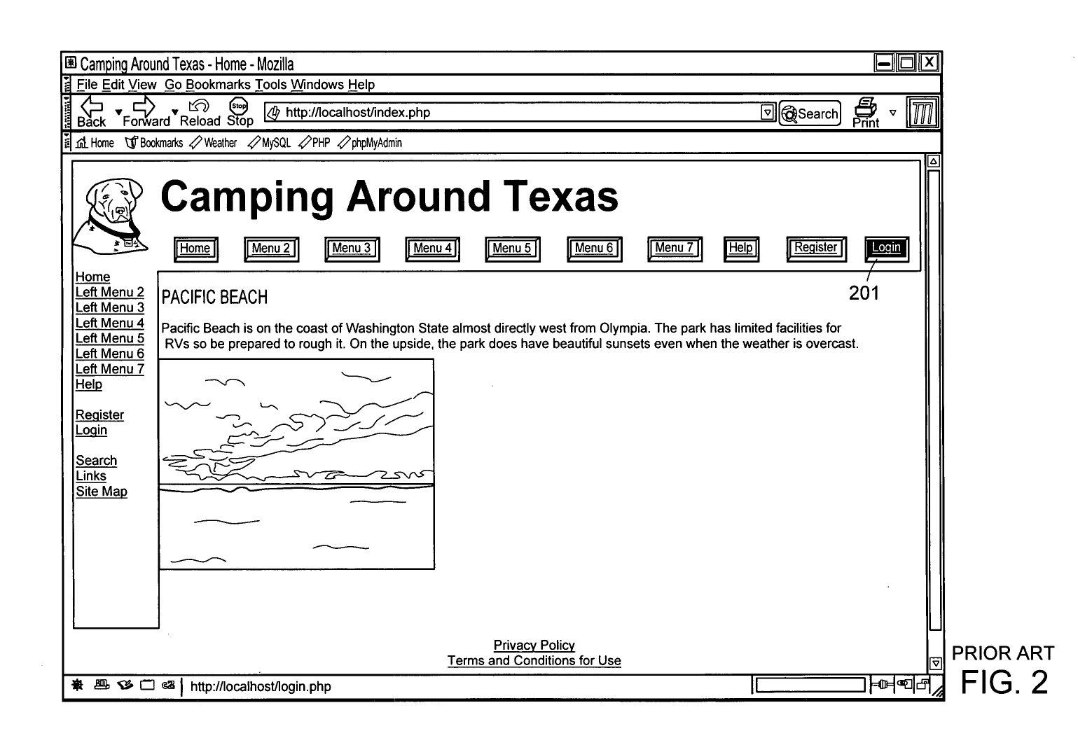

FIG. 2 shows a web page illustrating the functionality of buttons created using prior art Cascading Style Sheet techniques. As with buttons created based on JavaScript or ActiveX, the button 201 of FIG. 2, created using Cascading Style Sheets, reacts with the cursor to provide end-user feedback. When the cursor hovers over the “Login” button 201, the button's appearance changes as defined in the CSS file. Table 1 provides a code listing that might be used in a CSS file to define the style of the buttons shown in FIG. 2:

TABLE 1
CSS File Fragment for Web Page of Fig. 2

| | |
|---|---|
| td.popup { | |
| | background-color: #D900D9; |
| | text-align: center; |
| | font-weight: bold; |
| } | |
| a.popup:link { | |
| | font-family: Arial, Helvetica, sans-serif; |
| | font-size: small; |
| | font-style: normal; |
| | font-weight: bold; |
| | font-variant: normal; |
| | color: #FFCAFF; |
| | background-color: #D900D9; |
| | text-align: center; |
| | border-top-color: #4F004F; |
| | border-top-style: inset; |
| | border-right-style: inset; |
| | border-bottom-color: #4F004F; |
| | border-right-color: #4F004F; |
| | border-bottom-style: inset; |
| | border-left-color: #4F004F; |
| | border-left-style: inset; |
| } | |
| a.popup:visited { | |
| | font-family: Arial, Helvetica, sans-serif; |
| | font-size: small; |
| | font-style: normal; |
| | font-weight: bold; |
| | font-variant: normal; |
| | color: #FFCAFF; |
| | background-color: #D900D9; |
| | text-align: center; |
| | border-top-color: #4F004F; |
| | border-top-style: inset; |
| | border-right-style: inset; |
| | border-bottom-color: #4F004F; |
| | border-right-color: #4F004F; |
| | border-bottom-style: inset; |
| | border-left-color: #4F004F; |
| | border-left-style: inset; |
| } | |
| a.popup:hover { | |
| | font-family: Arial, Helvetica, sans-serif; |
| | font-size: small; |
| | font-style: normal; |
| | font-weight: bold; |
| | font-variant: normal; |
| | color: #4F004F; |
| | background-color: #FFCAFF; |
| | text-align: center; |
| | border-top-color: #4F004F; |
| | border-top-style: inset; |
| | border-right-style: inset; |
| | border-bottom-color: #4F004F; |
| | border-right-color: #4F004F; |
| | border-bottom-style: inset; |
| | border-left-color: #4F004F; |
| | border-left-style: inset; |
| } | |
| a.popup:active { | |
| | font-family: Arial, Helvetica, sans-serif; |
| | font-size: small; |
| | font-style: normal; |
| | font-weight: bold; |
| | font-variant: normal; |
| | color: #FFCAFF; |
| | background-color: #D900D9; |
| | text-align: center; |
| | border-top-color: #4F004F; |
| | border-top-style: inset; |
| | border-right-style: inset; |
| | border-bottom-color: #4F004F; |
| | border-right-color: #4F004F; |
| | border-bottom-style: inset; |
| | border-left-color: #4F004F; |
| | border-left-style: inset; |
| } | |

The portion of an HTML file that controls the button row of the web page of FIG. 2, under prior art techniques, might be as listed in Table 2:

TABLE 2
HTML File Fragment for Web Page of FIG. 2

```
<table width=”100%” border=”0”>
  <tr>
    <td class=”popup”><a href=”index.php” class=”popup”>Home</a>
    </td>
    <td class=”popup”><a href=”index.php” class=”popup”>Menu 2</a>
    </td>
    <td class=”popup”><a href=”index.php” class=”popup”>Menu 3</a>
    </td>
    <td class=”popup”><a href=”index.php” class=”popup”>Menu 4</a>
    </td>
    <td class=”popup”><a href=”index.php” class=”popup”>Menu 5</a>
    </td>
    <td class=”popup”><a href=”index.php” class=”popup”>Menu 6</a>
    </td>
    <td class=”popup”><a href=”index.php” class=”popup”>Menu 7</a>
    </td>
    <td class=”popup”><a href=”Help.php” class=”popup”>Help</a>
    </td>
    <td class=”popup”><a href=”Profile.php” class=”popup”>Profile</a>
    </td>
    <td class=”popup”><a href=”Logout.php” class=”popup”>Logout</a>
    </td>
    <td class=”popup”><a href=”Register.php” class=”popup”>Register
    </a></td>
    <td class=”popup”><a href=”Login.php” class=”popup”>Login</a>
    </td>
  </tr>
</table>
```

In creating the buttons of the web page of FIG. 2, the “class” directive in the HTML code in Table 2 says to use the CSS class style called “popup,” which is defined in the CSS file fragment of Table 1.

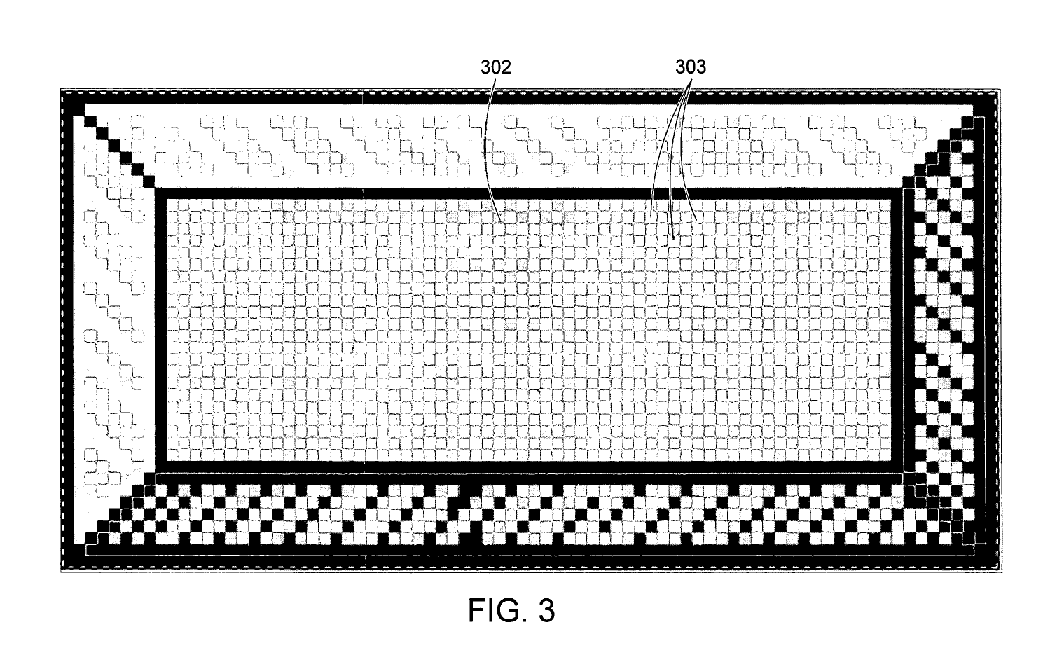

By contrast with the web pages of FIGS. 1 and 2, in which buttons and borders are created using prior art Cascading Style Sheet techniques, an embodiment according to the invention provides graphics picture elements that can be used for borders and buttons that take on the characteristics of the underlying display color beneath the border or button element. FIG. 3 shows a graphics file that forms a button on the screen, in accordance with an embodiment of the invention. The graphics picture (for example, a GIF) of FIG. 3 is as displayed in Adobe Photoshop Elements, at 800% magnification. A checkerboard pattern 302 in the central part of the button allows the background color, over which the button is displayed, to show through transparent portions, which are represented as white squares 303.

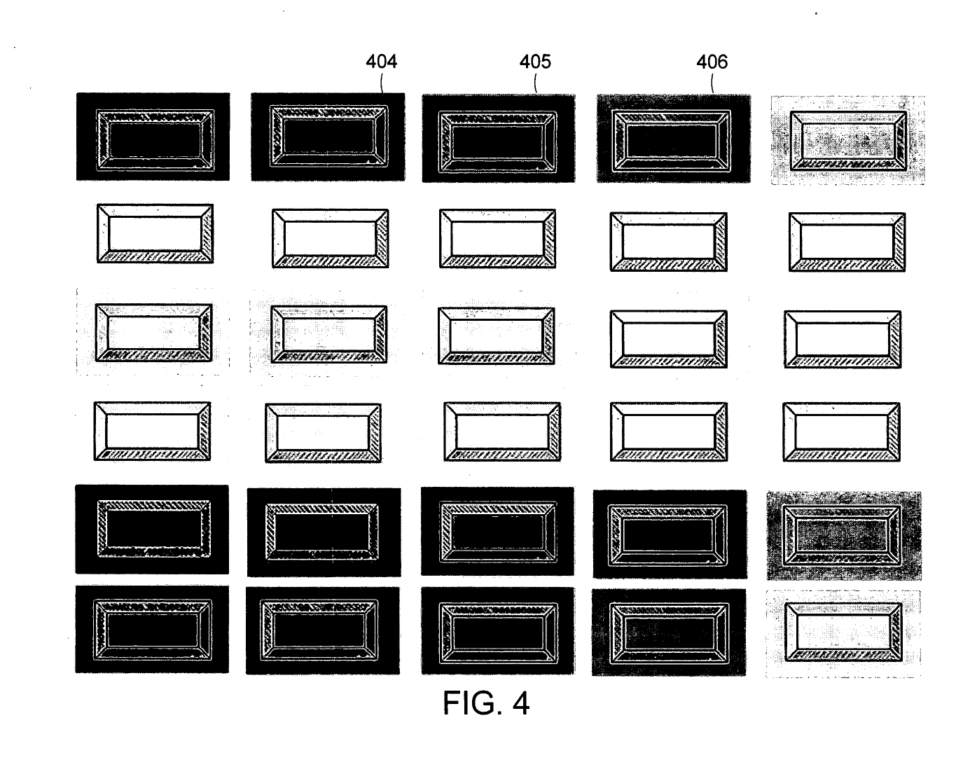

FIG. 4 illustrates the interaction between the button of FIG. 3 and a variety of different background colors, in accordance with an embodiment of the invention. The button of FIG. 3 was replicated to overlay a number of different backgrounds, such as backgrounds 404-406, and in each case the button can be seen to provide the visual effect of taking on the color of the background. In this way, the graphics file for the button need not be changed when the background color of the web page is changed. Thus, the disadvantage of needing to modify the graphics file for each button, as is required with prior art techniques, is avoided.

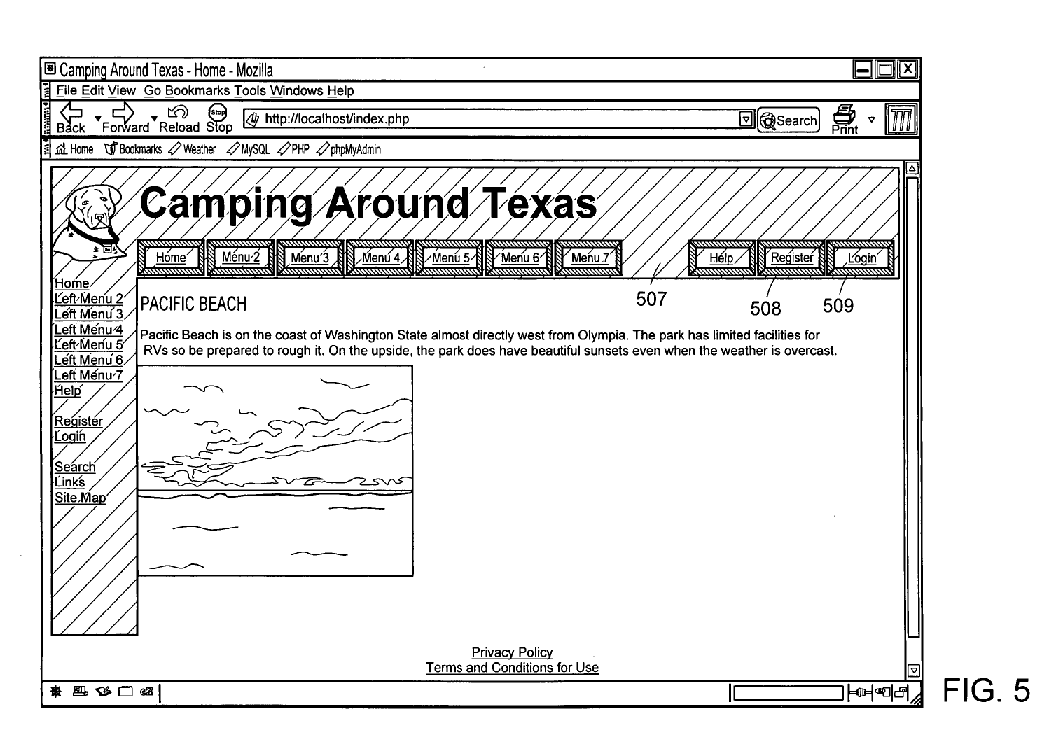

FIG. 5 shows a similar web page to that of FIGS. 1 and 2, modified to use buttons according to an embodiment of the invention. A change to the background color defined by the Cascading Style Sheet, such as a change to background color 507, automatically interacts with the buttons 508 and 509 to create the visual effect of the button having the same color as the background. The buttons 508 and 509 may be used to provide a linking functionality via the graphical browser interface, such as by providing a hyperlink in the typical way of a web page.

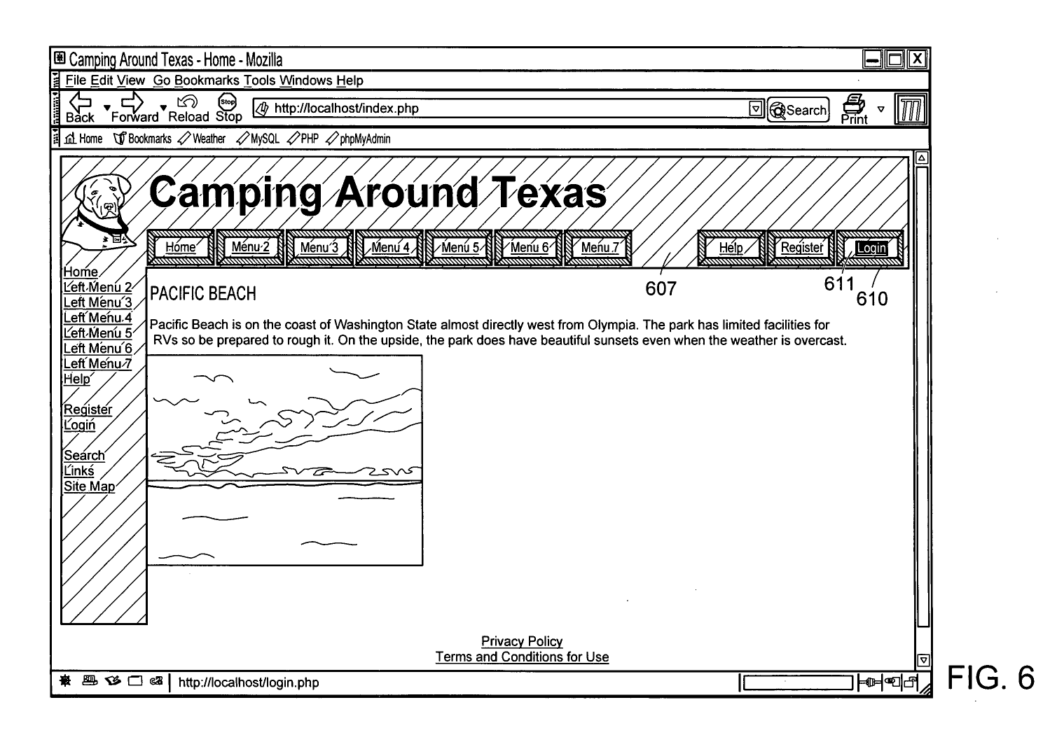

FIG. 6 shows a web page in which a button according to an embodiment of the invention exhibits the same mouse-over behavior as in the prior art web page of FIGS. 1 and 2. The “Login” button 610 of FIG. 6 still reacts to a hovering cursor in the same way as did the button 201 of FIG. 2. However, because button 610 uses the embodiment of FIGS. 3 and 4, it takes on the same color 611, outside the word “Login,” as the background 607.

Table 3 shows how the CSS file of Table 1 is modified to use the button image of FIG. 3, in accordance with an embodiment of the invention. For example, note that the fourth line of the td.popup section is added to refer to the Button image:

background-image: url (images/Button4%20copy.gif);

The full CSS fragment incorporating the Button image is:

TABLE 3
CSS File Fragment for Web Page of Fig. 5

| | |
|---|---|
| td.popupBlank { | |
| | background-color: #D900D9; |
| } | |
| td.popup { | |
| | background-color: #D900D9; |
| | text-align: center; |
| | font-weight: bold; |
| | background-image: url (images/Button4%20copy.gif); |
| | background-repeat: no-repeat; |
| | background-position: left-position; |
| } | |
| a.popup:link { | |
| | font-family: Arial, Helvetica, sans-serif; |
| | font-size: small; |
| | font-style: normal; |
| | font-weight: bold; |
| | font-variant: normal; |
| | color: #FFCAFF; |
| | background-color: #D900D9; |
| | text-align: center; |
| } | |
| a.popup:visited { | |
| | font-family: Arial, Helvetica, sans-serif; |
| | font-size: small; |
| | font-style: normal; |
| | font-weight: bold; |
| | font-variant: normal; |
| | color: #FFCAFF; |
| | background-color: #D900D9; |
| | text-align: center; |
| } | |
| a.popup:hover { | |
| | font-family: Arial, Helvetica, sans-serif; |
| | font-size: small; |
| | font-style: normal; |
| | font-weight: bold; |
| | font-variant: normal; |
| | color: #4F004F; |
| | background-color: #FFCAFF; |
| | text-align: center; |
| } | |
| a.popup:active { | |
| | font-family: Arial, Helvetica, sans-serif; |
| | font-size: small; |
| | font-style: normal; |
| | font-weight: bold; |
| | font-variant: normal; |
| | color: #FFCAFF; |
| | background-color: #D900D9; |
| | text-align: center; |
| } | |

Table 4 shows changes that may need to be made to the HTML file of Table 2 in order to use the button of FIG. 3, in accordance with an embodiment of the invention. For example, in Table 4, the button height and width are changed from that of Table 2.

TABLE 4
HTML File Fragment for Web Page of FIG. 5

```
<table width=”100%” border=”0”>
  <tr>
    <td class=”popup”> height=”40px” width=”75px”><a href=
”index.php”class=”popup”>Home</a></td>
    <td class=”popup”> height=”40px” width=”75px”><a href=
”index.php”class=”popup”>Menu 2</a></td>
    <td class=”popup”> height=”40px” width=”75px”><a href=
”index.php”class=”popup”>Menu 3</a></td>
    <td class=”popup”> height=”40px” width=”75px”><a href=
”index.php”class=”popup”>Menu 4</a></td>
    <td class=”popup”> height=”40px” width=”75px”><a href=
”index.php”class=”popup”>Menu 5</a></td>
    <td class=”popup”> height=”40px” width=”75px”><a href=
”index.php”class=”popup”>Menu 6</a></td>
    <td class=”popup”> height=”40px” width=”75px”><a href=
”index.php”class=”popup”>Menu 7</a></td>
    <td class=”popupBlank” height=”40px”></td>
    <td class=”popup”> height=”40px” width=”75px”><a href=
”Help.php”class=”popup”>Help</a></td>
    <td class=”popup”> height=”40px” width=”75px”><a href=
”Profile.php”class=”popup”>Profile</a></td>
    <td class=”popup”> height=”40px” width=”75px”><a href=
”Logout.php”class=”popup”>Logout</a></td>
    <td class=”popup”> height=”40px” width=”75px”><a href=
”Register.php”class=”popup”>Register</a></td>
    <td class=”popup”> height=”40px” width=”75px”><a href=
”Login.php”class=”popup”>Login</a></td>
  </tr>
</table>
```

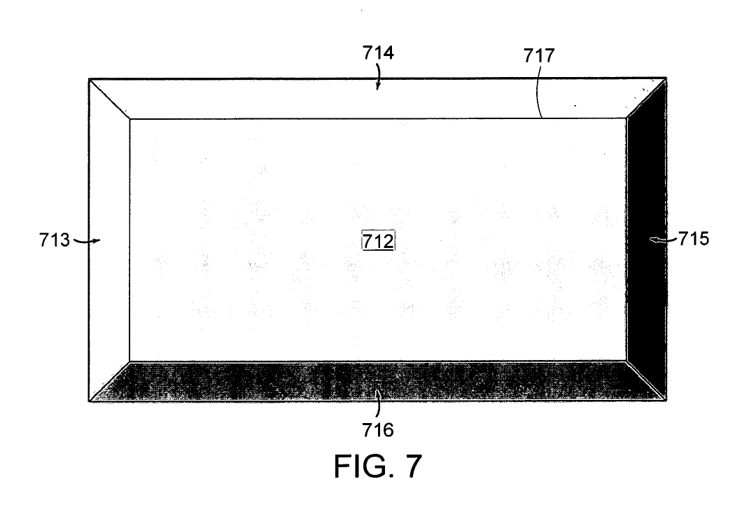

FIG. 7 shows a visual display element in which the visual effect of a three-dimensional button is accomplished through the use of shading and lines, in accordance with an embodiment of the invention. The central region 712 is the object's color (the “base color”). The region 713 is “two stops lighter than the base,” which means that it is lighter perceptually than region 714, which is “one stop lighter than the base,” and that region 714 is in turn perceptually lighter than the base color 712. Similarly, region 715 is two stops darker than the base, which means that it is perceptually darker than region 716, which in turn is perceptually darker than the base color 712. By using the shading scheme of regions 712 through 716, a visual effect of a three-dimension button is achieved in the display element of FIG. 7. The outlines of the regions 712 through 716 may be formed by solid border lines, such as line 717. In order to create the shading of FIG. 7, the central region 712 may be completely transparent, thereby allowing the background of the web page to be the base color of the button. Region 713 is filled in with a pattern, which, when combined with the background, produces the visual effect of being two stops lighter than the background. Similarly, patterns having lighter and darker visual effects when combined with the background (in accordance with the shading scheme described above) are used for regions 714-716. It should be appreciated that other designs for a button may be used; for instance, the button need not have four edges, but may for example be triangular or circular or some other shape; and may achieve a three-dimensional visual effect by a variety of different techniques, including shading.

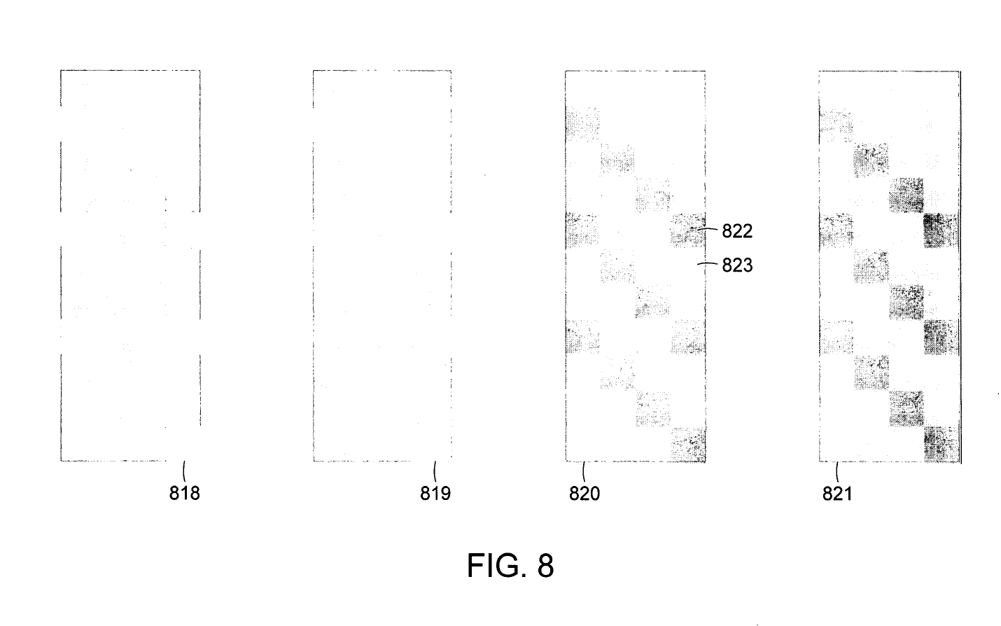

FIG. 8 illustrates how the edge regions of the button may be shaded to differing degrees using differing shades of gray shaded pixels, in order to create a three dimensional visual effect in accordance with an embodiment of the invention. The gray color used in the pattern in regions 818 to 821 gets darker from left to right across the figure. Such degrees of shading may be used to create the illusion of lightness and darkness for the different regions of the button of FIG. 7; for example, shading 818 may be used for region 713, shading 819 for region 714, shading 820 for region 715, and shading 821 for region 716. Each square 822 in the patterns 818-821 represents a single pixel in a GIF file (or other graphics file). Pixels at 823 are left transparent so that the background color shows through the button.

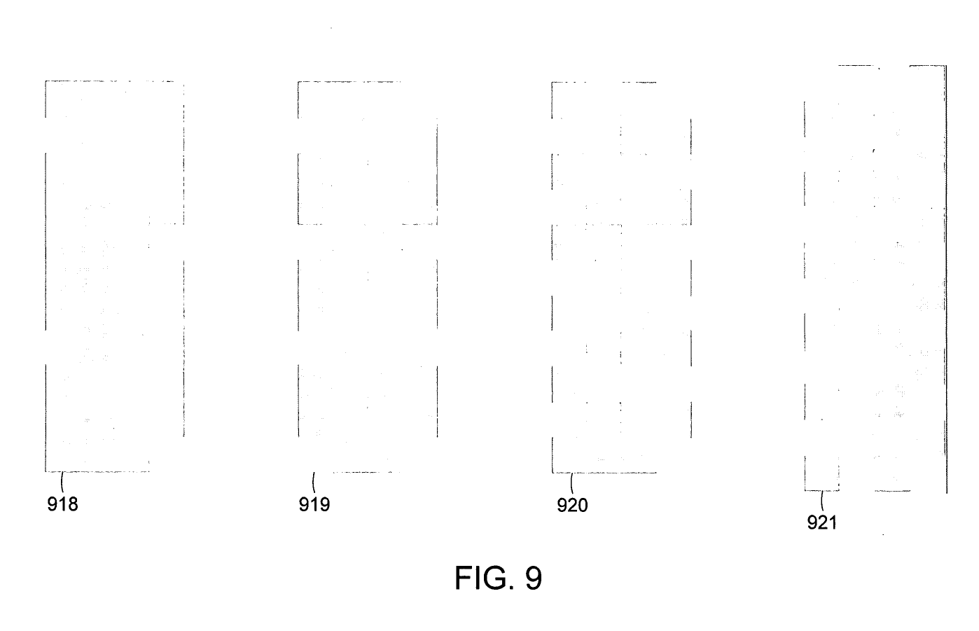

FIG. 9 illustrates how the edge regions of the button may be shaded to differing degrees using differing densities of gray shaded pixels, in order to create a three dimensional visual effect in accordance with an embodiment of the invention. The density of gray pixels used in the pattern in regions 918 to 921 gets darker from left to right across the figure. The same shade of gray is used, but the pattern of the pixels is modified to create the illusion of lightness and darkness. Any color pixel (not just gray) may be used to create a similar effect. As in FIG. 8, such degrees of shading may be used to create the illusion of lightness and darkness for the different regions of the button of FIG. 7; for example, shading 918 may be used for region 713, shading 919 for region 714, shading 920 for region 715, and shading 921 for region 716. Other techniques for creating the appearance of lightness and darkness may be used. For example, a combination of the shading of FIG. 8 with the varying pixel densities of FIG. 9 may be used.

An embodiment according to the invention helps to minimize the maintenance and development work required to support world class web sites. The method allows web developers to create a framework for creating buttons and borders (and other visual display elements) that change automatically to match background colors. Additionally, an embodiment according to the invention allows creating visually attractive buttons without using Java Script or ActiveX based controls. Given the security and privacy issues that arise from browsers supporting these types of controls, it is becoming increasingly common for end-users to disable these features in their browsers. Thus, avoiding their use provides advantages to web developers.

It should be appreciated that the methods described herein may be implemented in a variety of ways, including by using one or more processors to execute one or more sequences of instructions, which may be embodied on a computer-readable medium, or as a computer program product embodied on a propagated signal on a propagation medium.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for providing a visual display element for a graphical browser interface, the method comprising:
setting a background color for a region of the graphical browser interface; and
providing a visual display element overlaying the background color, wherein the visual display element provides a visual effect of having the same color as the background color, independent of changes to the background color.

2. A method according to claim 1, wherein the visual display element comprises a button providing a linking functionality via the graphical browser interface.

3. A method according to claim 1, wherein the visual display element comprises a border.

4. A method according to claim 1, wherein the visual display element comprises a checkerboard pattern of pixel illumination.

5. A method according to claim 1, wherein the background color is defined in a cascading style sheet.

6. A method according to claim 5, wherein a graphics file defining the visual display element is referred to in the cascading style sheet.

7. A method according to claim 1, wherein the visual display element provides a three dimensional visual effect.

8. A method according to claim 2, wherein the button provides a three dimensional visual effect, and wherein the method further comprises shading a plurality of edge regions of the button to differing degrees to create the three dimensional visual effect.

9. A method according to claim 8, wherein the differing degrees of shading of the plurality of edge regions include at least four edge regions comprising at least two different respective color shades lighter than a base color and at least two different respective color shades darker than a base color.

10. A method according to claim 8, wherein shading the edge regions to differing degrees comprises creating differing shades of gray shading patterns.

11. A method according to claim 8, wherein shading the edge regions to differing degrees is created by differing densities of gray shaded pixels.

12. A system for providing a visual display element for a graphical browser interface, the system comprising:
means for setting a background color for a region of the graphical browser interface; and
means for providing a visual display element overlaying the background color, wherein the visual display element provides a visual effect of having the same color as the background color, independent of changes to the background color.

13. A system according to claim 12, wherein the visual display element comprises a button providing a linking functionality via the graphical browser interface.

14. A system according to claim 12, wherein the background color is defined in a cascading style sheet.

15. A computer-readable medium carrying one or more sequences of instructions for providing a visual display element for a graphical browser interface, wherein execution of the one or more sequences of instructions by one or more processors causes the one or more processors to perform the steps of:
setting a background color for a region of the graphical browser interface; and
providing a visual display element overlaying the background color, wherein the visual display element provides a visual effect of having the same color as the background color, independent of changes to the background color.

16. A computer-readable medium according to claim 15, wherein the visual display element comprises a button providing a linking functionality via the graphical browser interface.

17. A computer-readable medium according to claim 15, wherein the background color is defined in a cascading style sheet.

18. A computer program propagated signal product embodied on a propagated
signal on a propagation medium, such propagated signal carrying one or more sequences of instructions for providing a visual display element for a graphical browser interface, wherein execution of the one or more sequences of instructions by one or more processors causes the one or more processors to perform the steps of:
setting a background color for a region of the graphical browser interface; and
providing a visual display element overlaying the background color, wherein the visual display element provides a visual effect of having the same color as the background color, independent of changes to the background color.

19. A computer program propagated signal product according to claim 18, wherein the visual display element comprises a button providing a linking functionality via the graphical browser interface.

20. A computer program propagated signal product according to claim 18, wherein the background color is defined in a cascading style sheet.
